(19) United States
(12) Patent Application Publication
(10) Pub. No.: US 2025/0366465 A1
(43) Pub. Date: Dec. 4, 2025

(54) STAND

(71) Applicant: Richard M. SCHWERER, Plainview, NY (US)

(72) Inventor: Richard M. SCHWERER, Plainview, NY (US)

(21) Appl. No.: 18/874,244

(22) PCT Filed: Jun. 15, 2023
(86) PCT No.: PCT/US2023/025407

§ 371 Date: Dec. 12, 2024

Related U.S. Application Data
(60) Provisional application No. 63/352,384, filed on Jun. 15, 2022.

(51) Int. Cl. A01M 31/02; E06C 1/20; E06C 7/18

(52) U.S. Cl. CPC A01M 31/02; E06C 1/20; E06C 7/188

(57) ABSTRACT

The present disclosure is directed to an apparatus that includes a front ladder having a plurality of steps, a framework connected to the front ladder at a first framework front ladder connection, and a support leg that is rotatably coupled to the framework.

### BACKGROUND OF THE DISCLOSURE

Typical tree stands, used to elevate a person above ground level for hunting, etc. have several drawbacks. Initially, they require a tree, having a specific diameter and little or no branches below a certain height. Further, typical tree stands are heavy and have a tendency to fall after being secured about a tree due to slipping between the tree stand and the tree, or a mechanical failure, including a failure of the strap mechanism used to secure the tree stand to the tree. Tree stand accidents have become the leading cause of hunting fatalities and injuries across the country.

What is desired is a device that overcomes these drawbacks and is safer, easier/more convenient to transport, set up, reposition and/or remove with minimal effort and minimal, if any, hand tools. Embodiments of the present disclosure provide devices and methods that address the above needs.

### SUMMARY OF THE DISCLOSURE

The present disclosure is directed to an apparatus that includes a front ladder having a plurality of steps, a framework connected to the front ladder at a first framework front ladder connection, and a support leg that is rotatably coupled to the framework.

### BRIEF DESCRIPTION OF THE DRAWINGS

The present disclosure will be better understood by reference to the following drawings, which are provided as illustrative of certain embodiments of the subject application, and not meant to limit the scope of the present disclosure.

FIG. 1 is a perspective view of one embodiment of an apparatus of the present disclosure.

FIG. 2 is a right side view of one embodiment of an apparatus of the present disclosure.

FIG. 3 is a left side view of one embodiment of an apparatus of the present disclosure.

FIG. 4 is an underneath view of one embodiment of an apparatus of the present disclosure.

FIG. 5 is a view of a portion of the support leg of the present disclosure.

### DETAILED DESCRIPTION OF THE DISCLOSURE

In the discussion and claims herein, the term “about” indicates that the value listed may be somewhat altered, as long as the alteration does not result in nonconformance of the process or device. For example, for some elements the term “about” can refer to a variation of ±0.1%, for other elements, the term “about” can refer to a variation of ±1% or ±10%, or any point therein.

As used herein, the term “substantially”, or “substantial”, is a broad term and is used in its ordinary sense, including, without limitation, being largely but not necessarily wholly that which is specified, which is equally applicable when used in a negative connotation to refer to the complete or near complete lack of an action, characteristic, property, state, structure, item, or result. For example, a surface that is “substantially” flat would mean either completely flat, or so nearly flat that the effect would be the same as if it were completely flat.

As used herein terms such as “a”, “an” and “the” are not intended to refer to only a singular entity but include the general class of which a specific example may be used for illustration.

As used herein, terms defined in the singular are intended to include those terms defined in the plural and vice versa.

References in the specification to “one embodiment”, “certain embodiments”, some embodiments” or “an embodiment”, indicate that the embodiment(s) described may include a particular feature or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

For purposes of the description hereinafter, the terms “upper”, “lower”, “right”, “left”, “vertical”, “horizontal”, “top”, “bottom”, and derivatives thereof shall relate to the invention, as it is oriented in the drawing figures. The terms “overlying”, “atop”, “positioned on” or “positioned atop” means that a first element, is present on a second element, wherein intervening elements interface between the first element and the second element. The term “direct contact” or “attached to” means that a first element and a second element are connected without any intermediary element at the interface of the two elements.

Reference herein to any numerical range expressly includes each numerical value (including fractional numbers and whole numbers) encompassed by that range. To illustrate, reference herein to a range of “at least 50” or “at least about 50” includes whole numbers of 50, 51, 52, 53, 54, 55, 56, 57, 58, 59, 60, etc., and fractional numbers 50.1, 50.2 50.3, 50.4, 50.5, 50.6, 50.7, 50.8, 50.9, etc. In a further illustration, reference herein to a range of “less than 50” or “less than about 50” includes whole numbers 49, 48, 47, 46, 45, 44, 43, 42, 41, 40, etc., and fractional numbers 49.9, 49.8, 49.7, 49.6, 49.5, 49.4, 49.3, 49.2, 49.1, 49.0, etc.

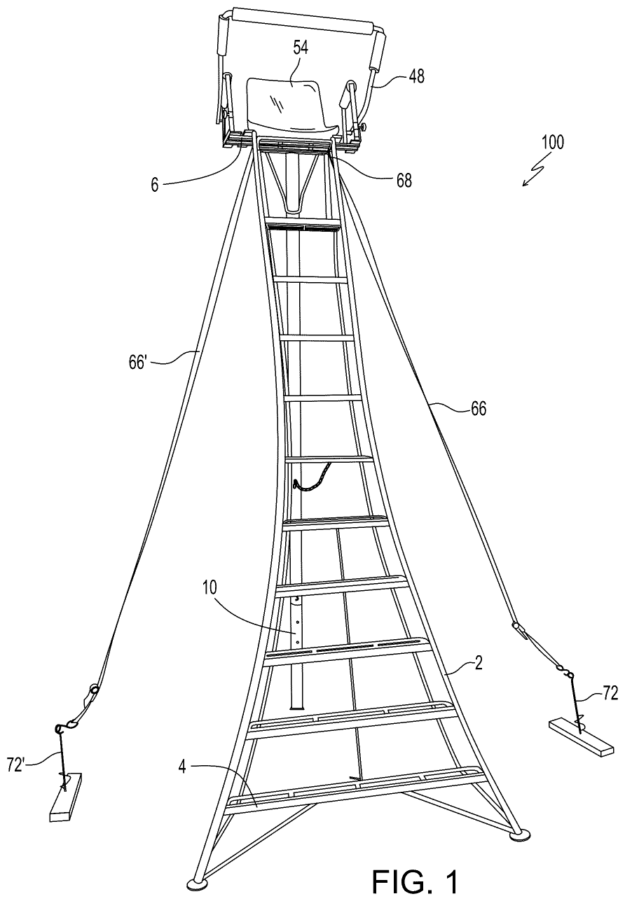

The present disclosure is directed to an apparatus, an embodiment of which, apparatus 100 is seen in FIG. 1. The apparatus 100 includes a front ladder 2, which includes a plurality of steps 4. These plurality of steps 4 can be operably attached to the front ladder 2 sides in any suitable way, such as through a bolt, rivet, strap, screw, snap, notch, weld, solder, adhesive, and combinations thereof. Alternatively/in addition to the operable attachment, the plurality of steps 4 can be integrally formed with the front ladder 2 sides.

As also can be seen in FIG. 1, the apparatus 100 includes a framework 6, with the framework 6 connected to the front ladder 2 at a first framework front ladder connection 8. The framework 6 is shown in one configuration in the present figures, but can be any suitable shape and structure that can support both the front ladder 2, a support leg 10 and the weight of at least one adult human sitting directly on the framework 6 (or sitting on an element attached to the framework 6 such as a seat). This first framework front ladder connection 8 is shown in more detail in other figures, but includes any suitable connection, such as the front ladder 2 being formed integrally with the framework 6, and also includes any suitable mechanical connection, such as through a joint, a hinge, a bolt, rivet, strap, screw, snap, notch, weld, solder, adhesive, and combinations thereof.

The apparatus 100 further includes the support leg 10, which is attached to the framework 6 through a rotatable coupling mechanism 11. This rotatable coupling mechanism 11 can be a hinge or any other suitable structure that makes rotation of the support leg 10 in comparison to the framework 8 possible. As used herein, the term hinge refers to a jointed or flexible device that connects and permits pivoting or turning of a part (support leg 10) to a stationary component (framework 6). Hinges include, but are not limited to, metal pivotable connectors, such as those used to fasten a door to frame, spring-loaded hinges, living hinges, and so forth. A living hinge permits pivotable movement of one member in relation to another connected member.

The framework 6, ladder 2 and support leg 10 can be formed of the same or different material selected from the group consisting of wood, plastic, glass, ceramic, metal(s), carbon-based materials, elastomer, synthetic materials such as nylon, rubber, and combinations thereof.

Other reference numbers of FIG. 1 will be described in relation to other figures below, with consistent reference numbers representing consistent components.

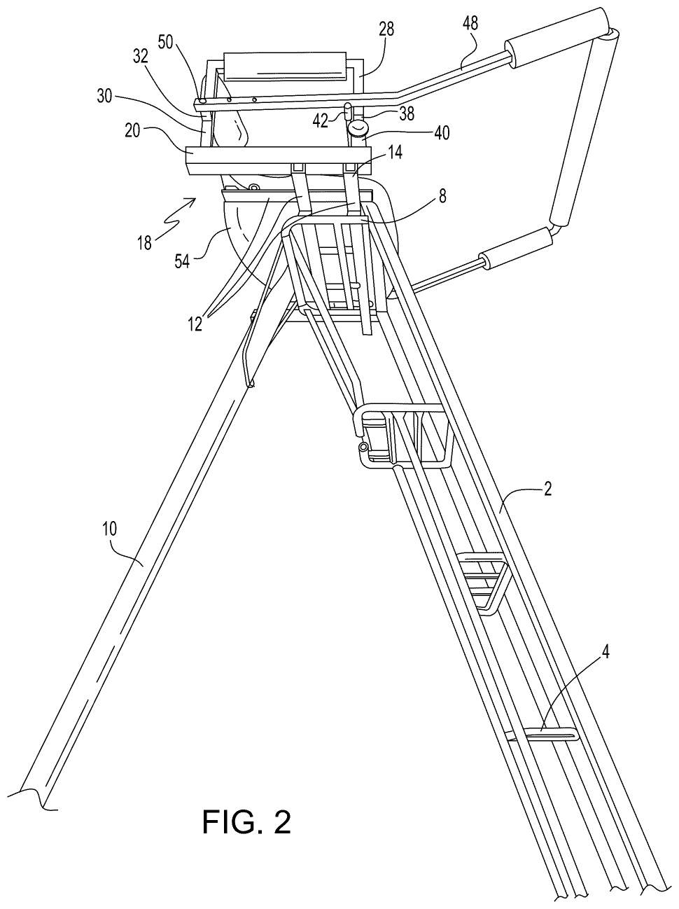

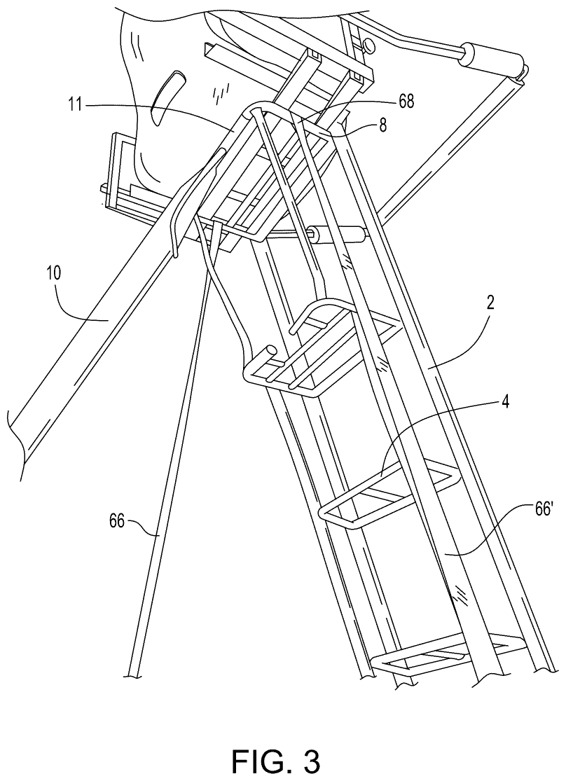

As seen in FIG. 2, the framework 8 comprises a framework base 12 and a framework support 18. The framework base 12 and the framework support 18 can be formed integrally, as one piece of material, or can be two or more pieces of material joined in any suitable way, such as a joint, a hinge, a bolt, rivet, strap, screw, snap, notch, weld, solder, adhesive, and combinations thereof. The framework base 12 comprises a first end 14 (substantially corresponding to the right hand side of the apparatus 12) and a second end 16 (substantially corresponding to the left hand side of the apparatus 12, as shown in FIG. 3).

The framework support 18 comprises a first framework support 20 and a second framework support 22 (shown in FIG. 3). The first framework support 20 and the second framework support 22 can be operably attached to the framework base 12 in any suitable way such as a joint, a hinge, a bolt, rivet, strap, screw, snap, notch, weld, solder, adhesive, and combinations thereof. Also, the first framework support 20 can be operably attached in a vicinity of the first end 14 (as seen in FIG. 2) and the second framework support 22 can be attached in a vicinity of the second end 16 (as seen in FIG. 3).

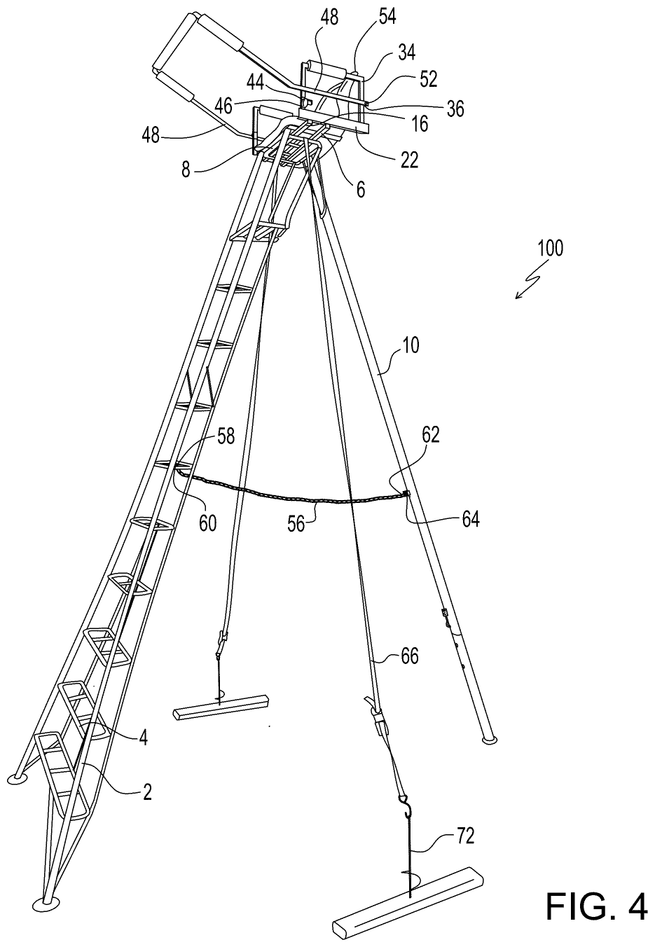

As can be seen in FIGS. 3 and 4, the first framework support 20 can include a first framework support first arm 28 and a first framework support second arm 30. The first framework support first arm 28 can be nearer the first framework front ladder connection 8 than the first framework support second arm 30, as illustrated in FIG. 2.

The first framework support first arm 28 and the first framework support second arm 30 can extend vertically from the first framework support 20, and can be operably attached to the first framework support in any suitable way such as a joint, a hinge, a bolt, rivet, strap, screw, snap, notch, weld, solder, adhesive, and combinations thereof. Optionally the first framework support first arm 28 and the first framework support second arm 30 can be a single piece of material that is connected on either end to the first framework support 20. In this optional configuration the area where the first framework support first arm 28 and the first framework support second arm 30 meet can be used to rest a user's arm, for example, during use of the apparatus 100.

Similarly to the first framework support 20, the second framework support 22 can include a second framework support first arm 32 and a second framework support second arm 34, as shown in FIG. 3. As seen in FIG. 3, the second framework support first arm 32 is nearer the first framework front ladder connection 8 than the second framework support second arm 34.

The second framework support first arm 32 and the second framework support second arm 34 are similarly situated and configured as the first framework support first arm 28 and the first framework support second arm 30.

As can be seen in FIG. 2, the first framework support second arm 30 can include a first rotatable connector 32. As can be seen in FIG. 3, the second framework support second arm 34 can include a second rotatable connector 36. The first rotatable connector 32 and the second rotatable connector 36 can be any suitable structure that is configured to secure another element, and allow that element to rotate in a plane substantially parallel to the height dimension of the apparatus 100.

In addition, as seen in FIG. 2, the first framework support first arm 28 can include a first connector 38, wherein the first connector 38 comprises a first sliding element 38 and a first peg 40, As can be seen in FIG. 3, the second framework support first arm 32 can include a second connector 44, wherein the second connector 44 comprises a second sliding element 46 and a second peg 48.

The first sliding element 38 and the second sliding element 46 are configured to partially, or wholly surround a circumference of the first framework support first arm 28 and the second framework support first arm 32, respectively.

The first sliding element 38 and the second sliding element 46 are also configured to slide along a length of the first framework support first arm 28, and slide along a length of the second framework support first arm 32, respectively. The first sliding element 38 and the second sliding element 46 are also configured so that they can be fixed at a point along the length of the first framework support first arm 28, and along the length of the second framework support first arm 32, respectively. The first sliding element 38 and the second sliding element 46 can be fixed to the first framework support first arm 28 and the second framework support first arm 32, respectively, in any suitable way, such as through the application of pressure on the first framework support first arm 28 and the second framework support first arm 32 from a screw supported by the first sliding element 38 and the second sliding element 46. Alternatively, or in addition to, a screw pressure, there can be one or more holes along the length of the first framework support first arm 28 and the second framework support first arm 32 such that a spring loaded pin attached to either the first sliding element 38 and the second sliding element 46 could enter the one or more holes, thus maintaining the position of the first sliding element 38 and the second sliding element 46.

The first peg 40 and the second peg 48, of the first connector 38 and the second connector 44, respectively, extend in a direction substantially perpendicular to the length direction of the first framework support first arm 28 and the second framework support first arm 32, respectively.

As seen in both FIGS. 2 and 3, the apparatus 100 can include a bar 48, the bar 48 having a first end 50 (shown in FIG. 2) and a second end 52 (shown in FIG. 3). The first end of the bar 50 is operably attached, in any suitable way, to the first rotatable connector 32. The second end of the bar 52 is operably attached, in any suitable way, to the second rotatable connector 36.

The bar 48 can be configured to rotate, about the first rotatable connector 32 and/or the second rotatable connector 36, and in the view of FIG. 2, rotate clockwise until the bar 48 contacts the first peg 42. In the view of FIG. 3 the bar 48 can be configured to rotate, about the first rotatable connector 32 and/or the second rotatable connector 36 in a counter-clockwise direction until the bar 48 contacts the second peg 48. Therefore, the bar 48 is configured to rotate and contact the first peg 42, the second peg 48, or both the first peg 42 and the second peg 48.

During use, the height of the first peg 42 and/or the second peg 48 can be changed by sliding the first connector 38 and/or the second connector 44 along the length of the first framework support first arm 28 and the second framework support first arm 32. Thus, if a user was in a seat 54, which itself is supported by the framework base 12, the user could modify the height of the first peg 42 and/or the second peg 48 to the user's desired height, such as a desired height to rest a weapon and/or firearm on. However, the user could modify the height of the first peg 42 and/or the second peg 48 to the user's desired height to support any instrument and/or the user themselves, such as the user's elbow or arm.

The seat 54 can be any suitable structure, having a back piece as shown in the figures, or just a bottom portion configured to support a seated user, which would typically be an adult human, but could also be younger humans, and/or humans of varying heights and weights, from about 40 pounds up to about 400 pounds or more, and between about three feet in height up to about seven feet in height or more.

As shown in FIG. 3, the apparatus 100 can also include a connecting element 56, having a connecting element length. This connecting element 56 can be any suitable material, such as a chain, cord, rope, cable, strap, etc., that can have a first end 58 operably attached to the front ladder 2 at any suitable location, such as a connecting element first point 60. This connecting element 56 can also have a second end 62 operably attached to the support leg 10 at any suitable location, such as at a connecting element second point 64.

The connecting element 56 is configured to prevent the connecting element first point 60 from moving a distance further than the connecting element length from the connecting element second point 64. For example, if the connecting element 56 is four feet long, as the support leg 10 is rotated in a clockwise direction away from the front ladder 2, movement of the support leg 10 is stopped once the connecting element first point 60 is four feet, or is about four feet, from the connecting element second point 64.

The apparatus 100 can also include a strap 66 (and optionally a strap 66′ that is the same or similar to the strap 66). The strap 66 can be composed of any material, such as a chain, cord, rope, cable, strap, etc., that has a first end 68 and a second end 70. The first end 68 can be operably attached to any portion of the framework base 12 (or any other suitable part of the apparatus 100, including to portions of the front ladder 2, the support leg 10 and/or the framework 8) and the second end 70 is configured to attach to an anchoring element 72. As seen in FIG. 3 the anchoring element 72 is a screw type anchor, but in other embodiments the anchoring element 72 can be a natural feature, such as a rock and/or portion of a tree, as well as other mechanical anchors, such as stakes, weights, and/or any suitable ground anchor.

The strap 66 can be configured to reduce and/or prevent movement of the apparatus 100 rotationally (clockwise or counter-clockwise in the view of FIG. 1), such that when a user is seated on the framework 8 and/or the seat 54, the apparatus 100 will be prevented from tipping in a direction (left or right direction in the view of FIG. 1).

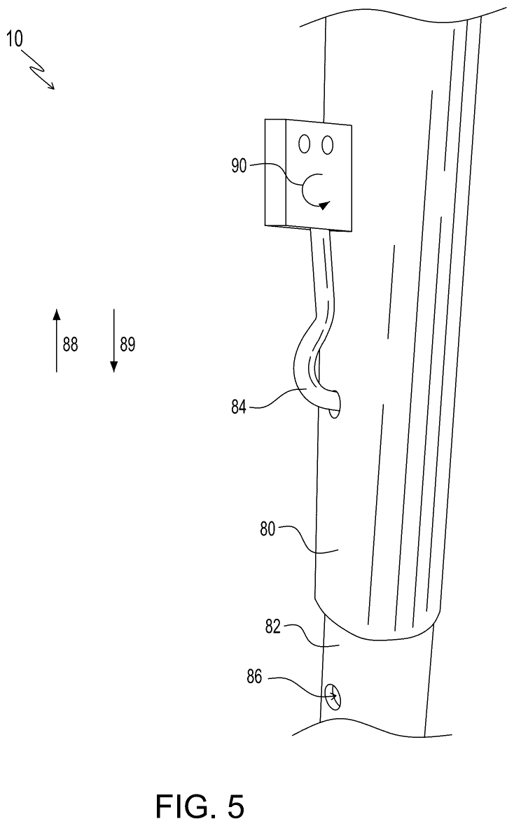

Another view of the apparatus 100 is shown in FIG. 5, specifically a magnified view of a portion of the support leg 10 is shown. Optionally, the support leg 10 can be configured to have an adjustable length. This optionally adjustable length can compensate for various terrains, such that the framework 8 can be made to be substantially level even if the terrain the apparatus 100 is on is not substantially level.

This adjustability in length is due to an adjustment mechanism 84. Adjustment mechanism 84 can be a hook and/or peg, or any suitable element that can extend through a hole of the support leg 10 outer sleeve 80 and the support leg 10 inner sleeve 82. The outer sleeve 80 is rotationally fixed to and rotatably coupled to the framework 8, while the inner sleeve 82 can slide, within the outer sleeve 80, vertically up, in the direction of arrow 88 (making the support leg 10 shorter) and vertically down, in the direction of arrow 89, (making the support leg 10 longer). To fix the support leg at a specific length, the adjustment mechanism 84 rotates in the direction of arrow 90, extending through the outer sleeve 80, and through an opening 86 of the inner sleeve 82. The inner sleeve 82 can include one or a plurality of openings 86 along the length of the inner sleeve 82.

The described embodiments and examples of the present disclosure are intended to be illustrative rather than restrictive and are not intended to represent every embodiment or example of the present disclosure. While the fundamental novel features of the disclosure as applied to various specific embodiments thereof have been shown, described, and pointed out, it will also be understood that various omissions, substitutions and changes in the form and details of the devices illustrated and in their operation, may be made by those skilled in the art without departing from the spirit of the disclosure. For example, it is expressly intended that all combinations of those elements and/or method steps which perform substantially the same function in substantially the same way to achieve the same results are within the scope of the disclosure. Moreover, it should be recognized that structures and/or elements and/or method steps shown and/or described in connection with any disclosed form or embodiment of the disclosure may be incorporated in any other disclosed or described or suggested form or embodiment as a general matter of design choice. Further, various modifications and variations can be made without departing from the spirit or scope of the disclosure as set forth in the following claims both literally and in equivalents recognized in law.

1. An apparatus comprising:
a front ladder comprising a plurality of steps
a framework, wherein the framework is connected to the front ladder at a first framework front ladder connection,
a support leg, wherein the support leg is rotatably coupled to the framework.

2. The apparatus of claim 1, wherein the framework comprises a framework base and a framework support, wherein the framework base comprises a first end and a second end.

3. The apparatus of claim 2, wherein the framework support comprises a first framework support and a second framework support.

4. The apparatus of claim 3, wherein the first framework support is attached in a vicinity of the first end and the second framework support is attached in a vicinity of the second end.

5. The apparatus of claim 4, wherein the first framework support comprises a first framework support first arm and a first framework support second arm, wherein the first framework support first arm is nearer the first framework front ladder connection than the first framework support second arm, and wherein the second framework support comprises a second framework support first arm and a second framework support second arm, wherein the second framework support first arm is nearer the first framework front ladder connection than the second framework support second arm.

6. The apparatus of claim 5, wherein the first framework support second arm comprises a first rotatable connector and the second framework support second arm comprise a second rotatable connector.

7. The apparatus of claim 6,
wherein the first framework support first arm comprises a first connector, wherein the first connector comprises a first sliding element and a first peg, wherein the first sliding element is configured to slide along a length of the first framework support first arm, and wherein the first sliding element is configured to be fixed at a point along the length of the first framework support first arm, and
wherein the second framework support first arm comprises a second connector, wherein the second connector comprises a second sliding element and a second peg, wherein the second sliding element is configured to slide along a length of the second framework support first arm, and wherein the second sliding element is configured to be fixed at a point along the length of the second framework support first arm

8. The apparatus of claim 6, further comprising a bar, wherein the bar comprises a first end and a second end, and wherein the first end of the bar is operably attached to the first rotatable connector and the second end of the bar is operably attached to the second rotatable connector.

9. The apparatus of claim 7, further comprising a bar, wherein the bar comprises a first end and a second end, and wherein the first end of the bar is operably attached to the first rotatable connector and the second end of the bar is operably attached to the second rotatable connector.

10. The apparatus of claim 9, wherein the bar is configured to rotate and contact the first peg, the second peg, or both the first peg and the second peg.

11. The apparatus of claim 2, wherein the framework base is configured to support a seat.

12. The apparatus of claim 1, further comprising a connecting element of a connecting element length, wherein the connecting element comprises a first end and a second end, wherein the first end of the connecting element is operably attached to the front ladder at a connecting element first point and the second end of the connecting element is operably attached to the support leg at a connecting element second point.

13. The apparatus of claim 12, wherein the connecting element is configured to prevent the connecting element first point from moving a distance further than the connecting element length from the connecting element second point.

14. The apparatus of claim 2, further comprising a strap, wherein the strap comprises a first end and a second end, wherein the first end is operably attached to the framework base and the second end is configured to attach to an anchoring element.

15. The apparatus of claim 1, wherein the support leg is configured to have an adjustable length.
